(19) United States
(12) Patent Application Publication
(10) Pub. No.: US 2019/0050767 A1
(43) Pub. Date: Feb. 14, 2019

(54) MEANS FOR STRATEGICALLY MANAGING AN EQUIPMENT OF A PHYSICAL NETWORK INFRASTRUCTURE

(71) Applicant: THE COSMO COMPANY, LYON (FR)

(72) Inventors: Bertrand RIX, CALUIRE ET CUIRE (FR); Gina CHIQUILLO MOJICA, CALUIRE ET CUIRE (FR); Mohamed Hedi BEN AMOR, VILLEURBANNE (FR); Micheline GUISERIX RAJON, VILLEURBANNE (FR); Serge BLUMENTHAL, PARIS (FR); Pierre STEVENIN, PALAISEAU (FR)

(21) Appl. No.: 16/077,658

(22) PCT Filed: Feb. 9, 2017
(86) PCT No.: PCT/FR2017/050298

§ 371 Date: Aug. 13, 2018

(30) Foreign Application Priority Data
Feb. 12, 2016 (FR) 16/51155

(51) Int. Cl. G06Q 10/06; G06Q 50/06

(52) U.S. Cl. CPC G06Q 10/0637; G06Q 50/06; G06F 17/5009; G06Q 10/0639; G06Q 10/0635

(57) ABSTRACT

The present invention pertains to the field of the strategic management of the equipment for physical network infrastructures, in particular for electrical and/or gas supply networks. More particularly, the invention deals with means adapted to: obtain a conceptual model of the physical network infrastructure and of business processes comprising: at least one type of equipment; and, at least one type of link between one or more types of equipment; and, at least one type of interaction between one or more types of equipment; and, at least one type of dynamics relating to a type of action; generate automatically, as a function of the conceptual model, a simulation computer program; collect a set of data relating to the physical network infrastructure and to business processes relating to the physical network infrastructure; create an instance of the conceptual model as a function of the collected set of data; obtain a set of actions to be undertaken by executing the simulation computer program, as a function of the set of data relating to the physical network infrastructure and to business processes relating to the physical network infrastructure; execute a set of actions in the physical network infrastructure.

### CROSS REFERENCE TO RELATED APPLICATIONS

This application is a National Stage of PCT Application No. PCT/FR2017/050298 filed on Feb. 9, 2017, which claims priority to French Patent Application No. 16/51155 filed on Feb. 12, 2016, the contents each of which are incorporated herein by reference thereto.

### TECHNICAL FIELD

The present invention relates to the field of strategically managing the equipment for physical transport or distribution, in particular energy distribution, network infrastructures. More particularly, the invention deals with means for optimizing the strategic planning by an automated process of a physical network infrastructure, in particular an electrical and/or a gas supply network or a railway network.

### BACKGROUND

The physical network infrastructure operators are today faced with a growing difficulty to maintain in operational condition existing infrastructures subject to the constraints related to the maintenance, operation and aging of the equipment. To cope with this problem, it becomes more than ever necessary to build new structures or to rehabilitate existing structures while carrying out, on a daily basis, maintenance and reconfiguration operations essential to the proper operation of the physical network. It is therefore particularly desirable for the operators to be able to optimally manage their management of equipment, by optimizing the planning through an automated process and by measuring the impact of this planning on their operational and accounting performance as well as on the induced risks.

Now, a physical network infrastructure is a complex system which is particularly difficult to model. Indeed, a physical network infrastructure has the following properties specific to the systems called complex systems:
the infrastructure is composed of several entities, each entity being governed by a state that characterizes it as well as a list of interactions; these entities may be of different type and nature;
the entities are connected together by interactions that can be of different natures: linear or not, static or dynamic, of a hierarchical order, etc.;
the infrastructure is subject to a dynamics, defined by actions and an achieving order.

Thus, optimizing the planning by an automated process, and measuring the performance of this planning, and the management of the equipment of a physical network infrastructure is only possible by taking into consideration all the physical and logical subsystems, as well as their interactions.

Today, there are simplified tools for strategic planning of physical network infrastructure investments. These tools are usually adapted for an annual planning and allow planning and implementing weekly or monthly operations only in a very rough manner. Moreover, they do not allow managing exhaustively the resources of the physical network of the infrastructure. Typically, these tools do not take into account neither all the physical constraints of the network registration due to the interdependence of the equipment nor all the human, budgetary and material resources. Accordingly, they do not allow identifying the potential conflicts between operations and all available resources. In addition, they are not adapted to compare different categories of equipment. Finally, these tools are mainly dedicated to the planning of the investments by renewing the equipment and do not take into account the maintenance of the equipment.

There are also maintenance management tools adapted to analyze existing data in order to define the priority operations from a list of future maintenance operations. However, these tools allow only a short-term planning and are inappropriate for taking into account interactions between renewal-related investment and maintenance-related expenses. In addition, they are not suitable for taking into account neither the constraints of asset management strategies nor the registration of the equipment, characteristic to a physical network infrastructure—and accordingly do not allow identifying the potential conflicts between the operations and all available resources. These tools are mainly dedicated to the planning of expenses and maintenance operations, but do not allow taking account the investments and the equipment renewal.

Thus, the patent document WO 2008/047386 describes a customer relationship management system, particularly the energy audit establishment, the asset data management, network failure analysis tools and crisis management tools. However, this type of tools does not allow identifying nor implementing optimal management of the equipment of an infrastructure, by taking into account the risks and performance measurements. In addition, this type of tools does not allow providing nor planning for the network failures nor for the human, financial and material resource requirements.

That is why there is still a need for optimization means through an automated process for managing the equipment of a physical network infrastructure, in particular an electrical network and/or a gas supply network, able to take into account the operation-related expenses, the maintenance operations, the investments, the renewal of equipment, operational and physical constraints of the equipment and infrastructure.

### BRIEF SUMMARY

An object of the invention is to provide optimization means by an automated process for managing the physical equipment of a physical network infrastructure, able to allow the optimization of the expense and investment strategies with determined resources, constraints, service quality level and risk level.

One or more of these objects are completed by the method for managing a set of equipment.

More particularly, according to a first aspect, the invention relates to a method for managing a set of equipment, said equipment being comprised in at least one physical network infrastructure. The method includes the following steps:
a first step of obtaining a conceptual model of the physical network infrastructure and of the business processes including:
   at least one type of equipment; and,
   at least one type of link between one or more type(s) of equipment; and,
   at least one type of interaction between one or more type(s) of equipment; and,
   at least one type of dynamics related to a type of action;
a second step of automatically generating, according to the conceptual model, a computer simulation program;
a third step of collecting a set of data related to the physical network infrastructure and to the business processes related to the physical network infrastructure;
a fourth step of creating an instance of the conceptual model;
a fifth step of obtaining a set of actions to be undertaken by execution of the computer simulation program, for a period between an initial year and a final year, by:
   for each year n comprised between the initial year and the final year:
      determining a planning for said yearn using the instantiated model;
   for each week s of said year n:
      by means of the instantiated model and of the planning for said year n, performing a simulation of the aging of the equipment of the set of equipment, for the week s of said year n, so as to obtain a list L_{s,n} of equipment likely to fail during the week s,
      updating the planning for said year n according to the list L_{s,n} of equipment likely to fail during the week s and at least one constraint;
      by means of the instantiated model and of the planning for said updated year n, performing a simulation of the aging of equipment of the set of equipment, for the week s of said year n, and checking if a condition is satisfied;
   determining at least one measurement related to the risks for said year n, using the planning for said year n and the results obtained for each week s of said year n during simulations of the aging of the equipment of the set of equipment;
a sixth step of executing the set of actions in the physical network infrastructure.

By using a conceptual model able to allow the representation of all the subsystems and their interactions within an infrastructure, the method according to the invention allows simulating at the same time the physical development, the business processes, but also all performance indicators, without having to simplify excessively the models, therefore by keeping a significant accuracy. By modeling the physical network infrastructure as a complex system, it is possible to take into account actual technical infrastructure constraints, business operational constraints, and to assess the impact of strategic decisions.

The method according to the invention allows in particular to take into account, in an effective and easy manner, possible modifications of the physical network infrastructure requiring an update of the computer simulation program. Indeed, it is possible through the invention to make a change to the conceptual model, the computer simulation program being then automatically generated. This type of operation is thus simplified because it is not necessary to intervene directly in the code of the computer simulation program. In addition, the separation between the conceptual model and the instance of the conceptual model allows obtaining a computer simulation program that can be used as it is by a plurality of physical network infrastructure managers.

The use of the method according to the invention allows a strategic planning of the expenses and investments.

The set of equipment may comprise at least one equipment comprised in a second infrastructure, for example a water, gas, oil supply infrastructure, a telecommunication infrastructure, a railway transport infrastructure, etc.

Particularly, the set of data related to the physical network infrastructure and to the business processes related to the physical network infrastructure may comprise data related to:
a description of one or more characteristic(s) of the maintenance and/or renewal operations for the equipment—a type of maintenance and/or renewal operation, a duration, a cost, a need for human skills, an impact on the aging; and/or,
a description of the organization of the operator of said infrastructure—a size, a number of teams, a list of skills, a geographical coverage, a list of availabilities; and/or,
a description of the stocks—a quantity of material, a type of material; and/or,
a description of financial data—a budget, a discount rate; and/or,
a description of the holding in equipment—an age, a type, a quantity, a geographical location, a technical capacity; and/or,
a description of the topology of the physical network of the infrastructure; and/or,
a description of constraints of operations induced by the use of the physical network of the infrastructure; and/or,
a description of the actual condition of the equipment—an apparent age, a state of degradation and use, —and/or of their constituent—dissolved gas, oil—read by inspections or sensors during interventions or automatically.

The computer simulation program can be in particular adapted during its execution, to provide:
at least one information related to a risk analysis based on taking into account performance key values, each of these performance key values being measured using one or more indicator(s) related to the physical network infrastructure; and/or,
at least one indicator complementary to the risk analysis.

The set of actions to be undertaken obtained during the fifth step is then function of said at least one information related to the risk analysis and/or of said at least one complementary indicator. Said at least one information related to a risk analysis can be obtained by implementing a risk analysis method using a consequence/probability-type matrix applied to the field of the physical network infrastructure.

During the fifth step, at least one global indicator may be still determined depending on said at least one risk-related measurement for each year in the period between the initial year and the final year. Particularly, in addition to the risk-related measurements, the following measurements can be also determined: number of failures, budget consumed, human resources used, number of operation conflicts, number of operations for each category—maintenance, renewal carried out, etc.

The conceptual model of the physical network infrastructure and of the business processes may include at least one type of suitable physical equipment including at least a property related to a level of degradation over time.

The conceptual model of the physical network infrastructure and of the business processes can include at least one type of renewal and maintenance policy related to said at least one type of physical equipment and to at least one type of associated operation.

The conceptual model of the physical network infrastructure and of the business processes may include at least one type of physical replacement equipment availability constraints.

The conceptual model of the physical network infrastructure and of the business processes may include at least one type of constraints of the physical network infrastructure, inherent to the maintenance of a determined level of customer power quality.

The conceptual model of the physical network infrastructure and of the business processes may include at least one type of human resource constraints.

The conceptual model of the physical network infrastructure and of the business processes may include at least one type of budgetary constraints.

The set of actions to be undertaken, for the period between the initial year and the final year, can be stored in a database and/or on a data medium. The set of actions to be undertaken can thus be consulted subsequently, and analyzed by an operator. The set of actions to be undertaken can be transferred automatically to one or more intervention team(s) that can thus perform them.

According to a second aspect, the invention relates to a computer program including instructions for performing the steps of the method according to the first aspect, when said program is executed by a processor.

Each of these programs can use any programming language, and be in the form of source code, object code, or intermediate code between source code and object code, such as in a partially compiled form, or in any other desirable form. Particularly, it is possible to use the C/C++ language, the language™ of the scripting languages, such as in particular tcl, javascript, python, perl that allow a code generation “on demand” and do not require significant overload for their generation or their modification.

According to a third aspect, the invention relates to a computer-readable recording medium on which a computer program is recorded comprising instructions for performing the steps of the method according to the first aspect.

The information medium can be any entity or of any device capable of storing the program. For example, the medium can include storage means, such as a ROM, for example a CD-ROM or a microelectronic circuit ROM, or a magnetic recording means, for example a floppy disk or a hard disk. On the other hand, the information medium may be a transmissible medium such as an electrical or optical signal, which can be conveyed by an electrical or optical cable, by radio or by other means. The program according to the invention can be particularly downloaded on an Internet or Intranet network. Alternatively, the information medium can be an integrated circuit in which the program is incorporated, the circuit being adapted to execute or to be used in the execution of the method in question.

According to a fourth aspect, the invention relates to a system for strategically planning and managing a set of equipment, said equipment being comprised in at least one physical network infrastructure. The system includes:
means adapted to obtain a conceptual model of the physical network infrastructure and of the business processes including:
   at least one type of equipment; and,
   at least one type of link between one or more type(s) of equipment; and,
   at least one type of interaction between one or more type(s) of equipment; and,
   at least one type of dynamics related to one type of action;
means adapted to generate automatically, according to the conceptual model, a computer simulation program;
means adapted to collect a set of data related to the physical network infrastructure and of the business processes related to the physical network infrastructure;
means adapted to create an instance of the conceptual model;
means adapted to obtain a set of actions to be undertaken by execution of the computer simulation program, for a period between an initial year and a final year, by:
   for each year n comprised between the initial year and the final year:
      determining a planning for said yearn using the instantiated model;
   for each week s of said year n:
      by means of the instantiated model and of the planning for said year n, performing a simulation of the aging of the equipment of the set of equipment, for the week s of said year n, so as to obtain a list L_{s,n} of equipment likely to fail during the week s,
      updating the planning for said year n according to the list L_{s,n} of equipment likely to fail during the week s and to at least one constraint;
      by means of the instantiated model and of the planning for said updated year n, performing a simulation of the aging of the equipment of the set of equipment, for the week s of said year n, and checking if a condition is satisfied;
   determining at least one risk-related measurement for said year n, using the planning for said year n and the results obtained for each week s of said year n during simulations of the aging of the equipment of the set of equipment;
means adapted to execute a set of actions in the physical network infrastructure.

### BRIEF DESCRIPTION OF THE DRAWINGS

Other features and advantages of the present invention will appear in the following description of embodiments with reference to the attached drawings, in which:

FIG. 1 is a block diagram of the steps of a method for planning and managing the equipment of a physical network infrastructure;

FIG. 2 is a diagram of a system for planning and managing equipment of a physical network infrastructure;

FIG. 3 is a diagram representing a conceptual model adapted to allow the representation of the different entities, links of the rules and dynamics of actions of a physical network infrastructure;

FIG. 4 is a block diagram of the sub-steps of the simulation step of the method for planning and managing the equipment of a physical network infrastructure.

### DETAILED DESCRIPTION

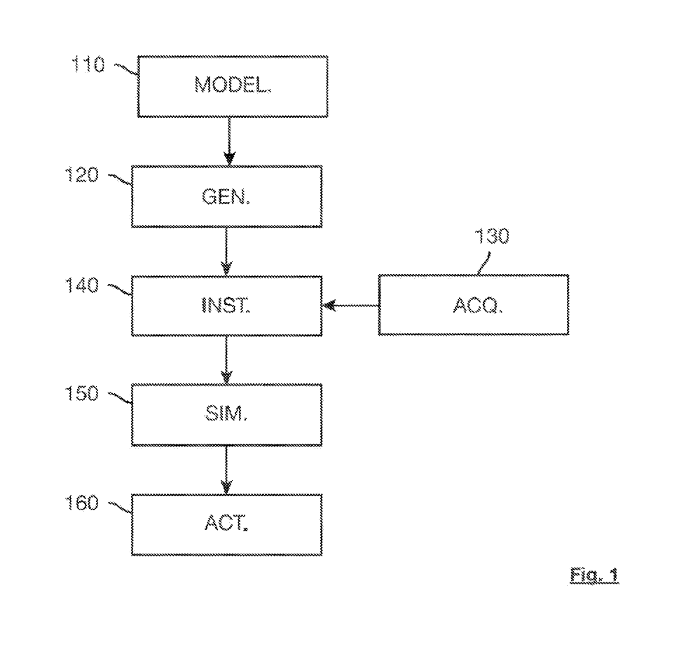

Referring to FIG. 1, the steps of a method for planning and managing the equipment of an infrastructure will now be described. The infrastructure can be particularly a physical network infrastructure, for example an electrical network or a gas supply network, or a railway network. The equipment is the physical entity comprised in the infrastructure. In the case of an infrastructure of the electrical network-type, the equipment is in particular the high-voltage or low-voltage equipment—transformers, circuit breakers, disconnectors, overhead lines, underground lines, pylons, etc. Part of the infrastructure equipment may also belong to and/or be shared with one or more other infrastructure(s), for example a water, gas, oil supply network, a communication network, a transport network or another physical network infrastructure.

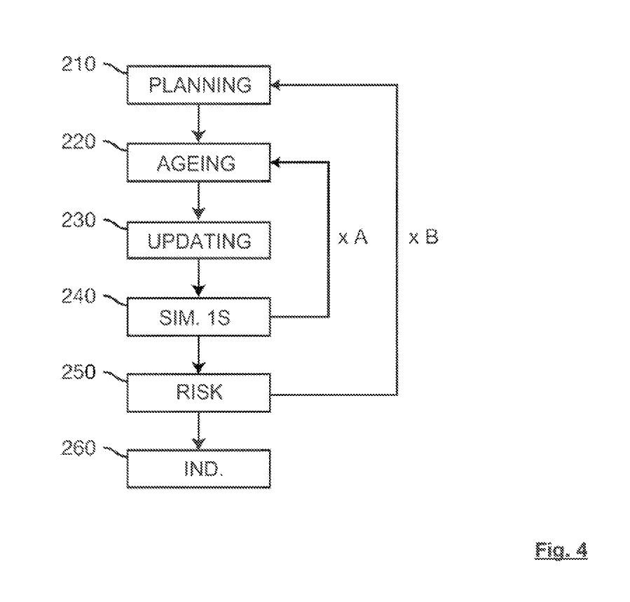

The steps of the method described below with reference to FIGS. 1 and 4 can be implemented in a software by executing a set of instructions or a program by a programmable processing device, such as a personal computer, a signal processing processor and/or a microcontroller; or alternatively in a hardware manner by a machine or a dedicated component, such a programmable logic circuit—for example of the type commonly referred to as “FPGA” for “Field-Programmable Gate Array”, or an integrated circuit specific to an application more commonly referred to as “ASIC” for “Application-Specific Integrated Circuit”.

The method includes a first step 110 of obtaining a conceptual model of the physical network infrastructure and of the business processes. The conceptual model is able to allow the representation of the different entities, links, interactions, and dynamics of actions related to the physical network infrastructure. The conceptual model can in particular be saved on a storage medium. The conceptual model is for example described by means of a metalanguage, particularly by means of an extensible markup language, more commonly referred to as XML for “Extensible Markup Language”.

During a second step 120, a computer simulation program is automatically generated according to the conceptual model. The computer simulation program can be obtained by automatic computer code generation. More particularly, during the second step 120, an automatic code generator can be used to interpret the data related to the conceptual model, then establish a correspondence between said data and the conceptual model described by means of a metalanguage, and generate automatically a computer source code related to a simulation program. The computer source code is for example a code source written in C++ language. The computer simulation program is then obtained by compiling the computer source code then by assembling the executable codes thus obtained into one executable program.

The method includes a third step 130 of obtaining data related to the physical network infrastructure and to the business processes of the operator of said infrastructure. The data thus obtained relate in particular to the information specific to the physical network infrastructure and to the business processes. Said data can be extracted from descriptive databases of the physical network infrastructure and of the business processes of the operator of said infrastructure. Said data, such as the apparent age of an equipment or the impact of the environment on the aging of an equipment, may come from measuring sensors installed on or near the equipment concerned. For example, the apparent age can be assessed for some types of equipment, by measuring a rate of gas dissolved in the oil, because this rate is directly function of the state of aging and of the reliability of said equipment. The impact of the environment can be assessed by cross-referencing the previous measurement with average environmental parameters such as hygrometry or temperature.

More particularly, data related to the physical network infrastructure may be one or more of the following non-exhaustive list:
a description of one or more characteristic(s) of the maintenance and/or renewal operations for the equipment—a type of maintenance and/or renewal operation, a duration, a cost, a need for human skills, an impact on the aging;
a description of the organization of the operator of said infrastructure—a size, number of teams, a list of skills, a geographical coverage, a list of availabilities, etc.;
a description of the stocks—a quantity of material, a type of material, etc.;
a description of financial data—a budget, a discount rate, etc.;
a description of the holding in equipment—an age, a type, a quantity, a geographical location, a technical capacity, etc.;
a description of the topology of the physical network of the infrastructure;
a description of constraints of operations induced by the use of the physical network of the infrastructure; and or,
a description of the actual condition of the equipment—an apparent age, a state of degradation and use, etc.—and of their constituent—dissolved gas, oil—read by inspections or sensors during interventions or automatically.

The data related to the physical network infrastructure can be obtained particularly from data of the current holding of the equipment, of their description of the state of degradation—read by the field data—budgetary, human and stock constraints, and of the network usage per cycle—some parts of the network are used differently in summer and winter, which changes the intervention constraints, because the charge transfers in case of registration of an equipment can create in some cases service quality or security risk issues—of the type total cutoff.

During a fourth step 140, an instance of the conceptual model is produced using the conceptual model obtained during the first step 110.

In one embodiment, the instance of the conceptual model can be obtained from the model by selecting a particular instance type, for example a model instance able to model a corrective maintenance process, of the repair type. The instance of the conceptual model can also be obtained from the model in particular process configuration choices.

In one embodiment, during the fourth step 140, the instance of the conceptual model, concerning the asset management—operations, strategies—, of the budget, of the stocks, of the human resources, of the risks, is adapted, according to data related to the physical network infrastructure and to the business processes of the operator of said infrastructure, collected at the moment of creating the instance.

The first and second steps are typically executed only during the first implementation of the steps of the method according to the invention. However, once the computer simulation program is obtained at the end of the second step, the first and second steps can be again executed to obtain a new computer simulation program, when there is observed in the infrastructure:
a significant change in a business rule, for example a new type of maintenance; and/or,
a use of a new category of equipment, for example a more efficient equipment but degrading very differently or requiring special interventions, for example in case of technological obsolescence; and/or
a significant change in the organization of the operator—in particular very constrained subcontract.

During a fifth step 150, the computer simulation program is executed and a set of actions is then produced, according to the data related to the physical network infrastructure and to the business processes of the operator of said infrastructure, obtained during the third step. Particularly, the computer simulation program is executed for each period of time, for example for each week. The computer simulation program is in particular adapted to determine one or more of the information from the following non-exhaustive list:
information related to the planning of an intervention for renewing a too old hardware equipment, particularly:
   information related to the allocation of the required resources—network shutdown, budgets, stocks, intervention teams;
   If a resource conflict is detected, information about the offset to a subsequent period of one or more intervention(s) on less priority equipment;
information related to the identification of a potential failure over the coming period according to the description of the condition of the equipment and of a probability of failure over a given period—typically during the next year;
information related to a re-planning of the interventions by taking into account the new needs to repair failures, particularly:
   an information related to the allocation of the required resources—network shutdown, budget, stocks, intervention teams;

if a resource conflict is detected, information about the offset to a subsequent period of one or more intervention(s) on less priority equipment;

Depending on the information produced by the computer simulation program, the set of actions is then determined. The set of actions corresponds to an intervention plan, that is to say a description of the list of operations over time and of their characteristics. The set of action can be transmitted automatically to a maintenance management device, for example to a computerized system for managing computer-assisted maintenance. Thus, the maintenance teams of the operator of the infrastructure can consult the programmed required operations, prepare and carry out the corresponding required interventions, in advance—corrective renewal—or as a consequence of a failure.

The computer simulation program is also adapted to determine, for each year, indicators, particularly:
indicators related to a risk analysis based on taking into account performance key values—usually referred to as “By” for “Business Values”—each being measured using one or more indicator(s)—usually referred to as “KPI” for “Key Performance Indicators”;
indicators complementary to the risk analysis necessary to take decisions such as a total number of failures, a ratio of operating expenses/capital investment expenses, corrective maintenance costs, etc.

The information related to the risk analysis relate typically to a consequence/probability matrix-type risk analysis applied to the field of electrical networks and detailed in several technical brochures from the CIGRE (International Committee of Large Electrical Networks), pre-standardization body for the electricity sector, particularly in the document entitled CIGRE Technical Brochure 309—“Asset management of transmission systems and associated CIGRE activities” Working Group C1.1 (2006) and in the document entitled CIGRE Technical Brochure 597 “Transmission asset risk management—Progress in application” Working Group C1.25 (2014). A consequence/probability matrix-type risk analysis allows placing on the same plane, for the calculation of risks, elements as different as costs and environmental releases for example, through a severity scale that is common to each performance key value defined a priori by the network manager. The severity scale typically has 4 levels: Moderate, Serious, Severe, Catastrophic. For an electrical network manager, it is possible to identify the following performance key values: Financial impact, Service quality, Third-party safety, Public image, Environment, Laws and Regulations, Interference of the regulator. The severity scale applied to each performance key value is then associated with a frequency scale of the dreaded events, to define in fine a risk matrix reflecting the acceptability of the risk by the network manager. It is from this matrix that the information related to the risk analysis can be determined.

In addition, during the fifth step, one or more of the following operations, among the following non-exhaustive list, may be also implemented:
exportation of the list of necessary interventions for each week, in tools for operationally monitoring and supervising the operations;
exportation of the list of the provided operations in anticipation of failures—resource reservation to repair or replace—, or need for renewal—identification of dates of interventions upstream-, or in recurring cycle—routine maintenance.

During a sixth step 160, the actions of the set of actions are executed in the physical network infrastructure. The operations executed thus allow maintaining the equipment as it is by preventing it from being degraded or by refurbishing it. This restoration will change the data describing the actual condition of the equipment, which will have an impact on the possible next implementation of the method according to the invention. One of the advantages of the method according to the invention is to allow the identification of early emerging phenomena, which would remain invisible by the implementation of the known methods of the prior art. The method according to the invention allows particularly to identify the effects of cascades where an event can produce a sequence of uncontrolled consequences in the infrastructure. The method according to the invention allows particularly to predict the catastrophic developments of the infrastructure, because it allows taking into account variations in the initial conditions, including when the latter are minimal, as well as the interactions of the different equipment.

Referring now to FIG. 4, in which the sub-steps of the fifth simulation step 150 are shown. During the fifth simulation step 150, the effects of aging of the infrastructure equipment are determined. More particularly, during the fifth simulation step 150, is implemented a dynamic process able to allow the determination:
of at least one measurement related to the aging, specific to each equipment of the infrastructure; and
of at least one measurement related to the deterioration, specific to each equipment of the infrastructure, due to external causes such as storms, accidents, damages, etc.

The measurement related to the aging specific to each equipment is determined in particular depending:
on at least one measurement related to the aging specific to one of the components said equipment; and,
on at least one measurement of the influence of the aging of said component on the other components of said equipment and all of said equipment.

By way of example:
the aging of a pylon depends on the state of wear of its paint;
the aging of an oleostatic-type power line is accelerated by the aging of the oil;
the aging of a gas pipeline is slowed down by its cathodic protections;
the aging of a railway rail depends on its only component, that is to say, the rail itself.

the measurement related to the aging specific to each component of an equipment can be obtained, by means of a function representing a linear process, said function having as an input parameter, an impact parameter of the environment, and as an output variable, a magnitude related to the apparent age of said equipment (as opposed to the actual age of said equipment). Thus, when a component is considered individually, the apparent age increases by a quantity equal to the impact of the environment at each simulation step. By considering a component when the latter is coupled to a second component, the apparent age varies according to the apparent age of the second component, and to the role played by the second component: an inhibiting role of aging or an accelerating role of aging. For example, two rails with the same actual age may have different apparent ages, in particular if the density of cracks observed proves to be different for each of the two rails. Two capacitors having an identical actual age may have different apparent ages, in particular the observed ambient average temperatures differ in their respective environments.

During the fifth simulation step 150, the deterioration for each equipment of the set of equipment of the infrastructure, due to external causes, is determined also through a stochastic process whose parameter is an annual failure rate due to external causes. The annual failure rate due to external causes is typically derived from historical data. In one embodiment, the annual failure rate is obtained from one or more database(s), at the inlet of the instantiated model, or configured by the user to test different scenarios.

Upon receipt of a request to execute a simulation on a period P between the year A₁ and the year A_{N}, for example after sending a request from a user, for each year Aₙ comprised between the year A₁ and the year A_{N}:
a planning Pₙ for the yearn is determined using the instantiated model, during a sub-step 210;
for each week s of the year Aₙ,
   during a sub-step 220, by means of the instantiated model and of the planning Pₙ, a simulation of the aging of the infrastructure equipment, for the week s of the year Aₙ, is carried out so as to obtain a list L_{s,n} of equipment likely to fail during the week s,
   during a sub-step 230, the planning Pₙ is updated in particular according to the list L_{s,n} of equipment likely to fall during the week s, and according to at least one constraint, for example a constraint related to the human resources, and/or to the financial resources and/or to the equipment of the network—possible registrations—, and/or stocks;
   during a sub-step 240, by means of the instantiated model and of the planning Pₙ updated during the sub-step 230, a simulation of the aging of the infrastructure equipment, for the week s of the year Aₙ, is again carried out, by taking into account the actions/operations previously carried out related in particular to the maintenance and/or to the renewal;
   during a sub-step 250, a measurement related to the risks for the year Aₙ is determined, by means of the planning Pₙ and of the results obtained for each week s of the year Aₙ during the simulations of the aging of the infrastructure equipment.

During the sub-step 220, for a set of equipment of the infrastructure, a measurement related to the aging is determined. In the following example, the method is described for an equipment E of the set of equipment of the infrastructure. The equipment E includes a component A coupled to a component B. However, this decomposition is not restrictive. Indeed, the equipment considered may include a larger number of components. The steps described below are then repeated for each equipment of the set of considered equipment.

During the sub-step 220, an death age AOD is determined for example by random draw, for each of the components of the equipment E, according to a distribution associated with the law of aging of the typical profile of equipment—generally of the Weibull type.

During the sub-step 220, the apparent age A (t+Δt) of the component A at time t+Δt and the apparent age B (t+Δt) of the component B at time t+Δt are determined, using the following mathematical expressions:

A(t+Δt)=A₁(t+Δt)−γ(B(t))

B(t+Δt)=B₁(t+Δt)

with:

A₁ a mathematical function, describing the aging process of the component A;

B₁ a mathematical function, describing the aging process of the component B;

A(t) the value, at a time t, of the apparent age of the component A;

B(t) the value, at a time t, of the apparent age of the component B.

Δt is a time interval, expressed in year. Typically, Δt is chosen equal to 1/52, so that the time interval corresponds substantially to the duration of a week, a year including on average of 52 weeks. Thus, the period P expressed in year and comprised between the year A₁ and A_{N} is spread over 52×Δt weeks. A (t+Δt) and B (t+Δt) are then assessed for all weeks of the year considered.

The development of the functions A₁ and B₁ can be expressed by the following mathematical expressions:

A₁(t+Δt)=A(t)+β_{A}×ΔT

B₁(t+Δt)=B(t)+β_{AB}×Δt

with:

β_{A} a parameter related to the impact of the environment on the equipment A;

β_{B} a parameter related to the impact of the environment on the equipment B;

(γB(t)) a function able to quantify the influence of the apparent age of the component B on the component A.

The value of the parameter β_{A}, respectively β_{B}, is generally chosen substantially equal to 1. When the environment of the equipment A, respectively B, is very corrosive, for example at the seaside for overhead power lines or a very wet soil for gas pipelines, the value of the parameter β_{A}, respectively β_{B}, is chosen greater than 1. When the environment of the equipment A, respectively B, is a non-corrosive environment, the value of the parameter β_{A}, respectively β_{B}, is chosen less than 1. The usual values of β_{A} and β_{B} are discretized by taking into account a finite number of categories, all of these values can be obtained, at the inlet, from databases accessible via a network.

γ(B(t)) corresponds to a nonlinear coupling function, which can be expressed using a sigmoid function of the Hill sigmoid type. Particularly, γ(B(t)) can be expressed as follows:

$$γ ( B ( t ) ) = [ p \times [ 1 - \frac{{( B ( t ) )}^{n}}{{( {B}_{AOD} )}^{n} + {( B ( t ) )}^{n}} ] + q ] \times Δt$$

with

p, q and n parameters allowing to control the stiffness and scale of the sigmoid γ(B(t)); the parameters allow particularly, at the end of a calibration phase, to determine the role that the component B plays in the aging of the component A;

B_{AOD} a parameter related to the death age AOD_{B} of the equipment B.

During the sub-step 220, the apparent age of the component A is compared to the dead age AOD_{A} of the equipment A. If the apparent age of the component A is substantially greater than or equal to the death age AOD_{A} of the equipment A, the equipment E is then considered as likely to fail and is then added to the list L_{s,n}.

The initial apparent age and all the simulation parameters of the aging are provided at the inlet.

During the sub-step 230, the planning Pₙ can be updated by:
resolving the conflicts between urgent maintenance actions to be carried out on the equipment of the list L_{s,n} and investment actions concerning said equipment of the list L_{s,n} and provided in advance during an initial planning; and/or,
releasing, if necessary, stock resources and human resources initially allocated for other equipment; and/or,
transferring, if necessary, investment actions in order to preserve an acceptable level of power quality for the customer of the network.

During the sub-step 240, according to the instantiated model and to the planning Pₙ for said updated year n, all the actions of the planning Pₙ for the week s of said year n can then be implemented and/or their forces can be taken into account. Indeed, the aging of the equipment can be sowed down by the maintenance actions applied, in particular by the decrease of the apparent age by at least one of the components of the equipment of the infrastructure. For example, the apparent age of the painting is reset to zero for the electric pylons during a paint-type maintenance or the apparent age of the oil is reduced as a result of a degassing-type maintenance of the oleostatic lines. Repairing a rail reduces its apparent age. Also, the maintenance actions can be parameterized by an impact magnitude of the maintenance, this parameter being obtained for example from databases and can be represented by a percentage, obtained in particular by means of field maintenance readings.

During a sub-step 250, global indicators for the period P are determined according to risk-related measurements for each of the years Aₙ of the P period. Particularly, in addition to the risk-related measurements, the following measurements can also be determined: number of failures, budget consumed, human resources used, number of operation conflicts, numbers of operations for each category—maintenance, renewal—performed, etc.

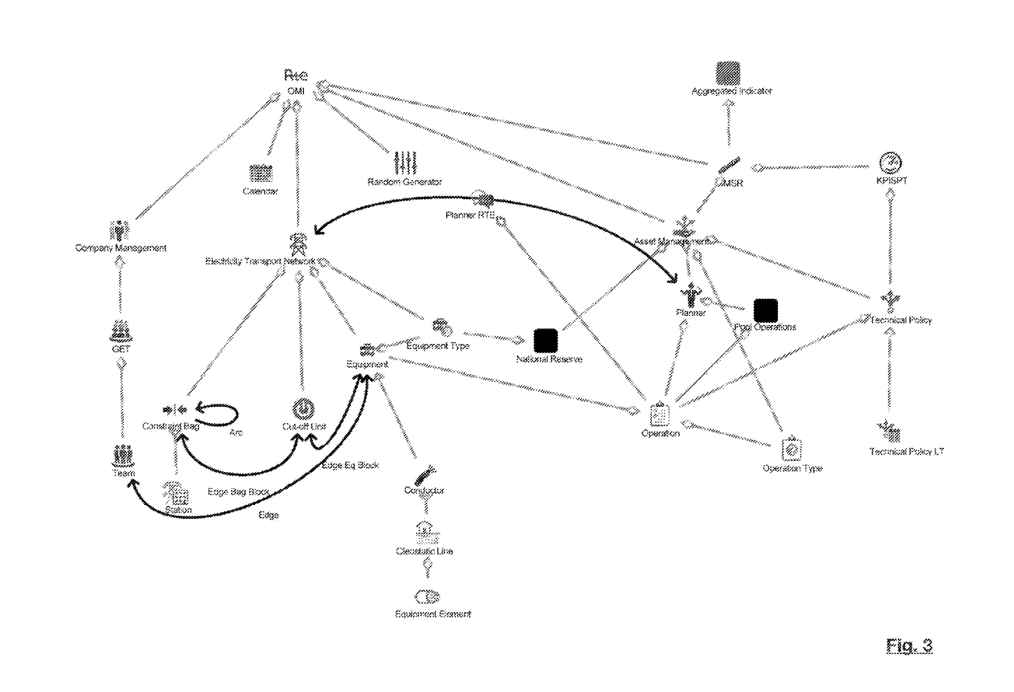

Referring now to FIG. 3, representing the conceptual model, according to an embodiment, adapted to allow the representation of the different entities, links, interactions and action dynamics of a physical network infrastructure. In the example of a physical network infrastructure forming an electricity transport network, the conceptual model is adapted to allow the representation of said network, substantially as a whole, by means of types of entities, in particular the following types of entities:
at least one type of physical equipment—for example, high-voltage and low-voltage equipment—including a property related to their degradation over time;
at least one type of renewal and maintenance policy of the physical equipment and operations associated;
at least one type of network constraints, inherent to the maintenance of a determined level of customer power quality—for example, when an electrical structure is cut off from the network because of maintenance, the nearby service structures must be able to handle an additional supply of current passing therethrough;
at least one type of human resource constraints, whether internal—for example the maintenance teams—or external—for example the supplier teams;
at least one type of physical replacement equipment availability constraints, for example related to the stocks;
at least one type of budgetary constraint, for example constraints related to the budget estimates.

Concerning said at least one type of network constraints, inherent to the maintenance of a determined level of customer power quality—for example, it should be noted that the network resiliency is ensured by the existence of multiple transport paths. The network must be able to continue to operate in case of a fortuitous failure and this even if it is the subject of maintenance or investment operations. Consequently, the break of a path causes a transfer of the quantity transported on alternative paths. Whether it is an electric charge, a train or a quantity of gas, this charge transfer is limited in quantity. For example, electrical conductors cannot exceed a certain electrical intensity, the railways have speed limits which in turn limit the possible number of trains on only one track and finally the gas pipelines have a maximum handled pressure. This type of constraint is referred to as the registration constraint. The instantiated model can particularly take into account the registration constraints, by taking into account in particular local neighborhood relationships between equipment, modeled by an abstract entity called “Constraint Bag”. The equipment that cannot be registered together belong to the same constraint bag. Finally, these registration constraints can be parametrizable, so that only a limited number of equipment can be registered at a time.

In the case of an electrical-type network, the conceptual model includes all the types necessary for the representation of the equipment and their interactions, particularly the types related to the high-voltage or low-voltage equipment—transformers, circuit breakers, disconnectors, overhead lines, underground lines, pylons—and their interactions. The conceptual model is still adapted to allow taking into account the dynamic interactions that exist between the equipment, resources, and constraints. For example, accelerating the achievement of a particular policy may lead to a transfer of achievement of other policies due to constraints related to the human resources.

The conceptual model is still adapted to allow the description of the planning of operations on the equipment of the physical network infrastructure, by taking into account all the constraints. The description of the planning of operations is still adapted to allow resolving resource conflicts in an automated way.

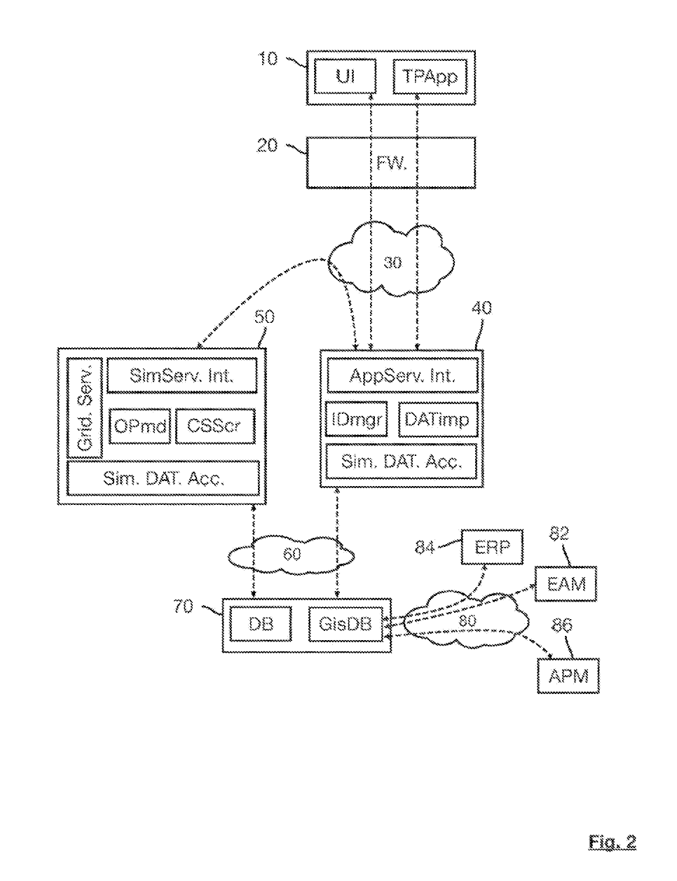

Referring now to FIG. 2, showing a system for strategically planning and managing a set of equipment, said equipment being comprised in at least one physical network infrastructure. The strategic planning and management system is in particular adapted to implement the steps of the method for planning and managing the equipment of an infrastructure, described above.

The system includes a terminal module 10, a secure access module 20 to a communication network 30, an application module 40, a simulation module 50, a communication network 60, a data storage module 70, an external resource management module 82 and an external planning module 84.

The terminal module 10 typically includes a user interface and may include a submodule allowing to use third-party applications. The Terminal module 10 may in particular be provided with a central processing unit (more generally referred to as “CPU” for “Central Processing Unit”) and with random access memories (more generally referred to as “RAM” for “Random-Access Memory”). The terminal module 10 is coupled to the secure access module 20 to access the communication network 30, establish data links with the application module 40. For example, the communication network 30 can be a local network and/or internet. The application module 40 typically includes a processing device provided with a central processing unit (more generally referred to as “CPU” for “Central” Processing Unit”) and with random access memories (more generally referred to as “RAM” for “Random-Access Memory”). The application module includes means for accessing the data storage module 70 via the communication network 60. The data storage module 70 includes storage means 44, for example hard disks and/or electronic discs, as well as a database management system. The simulation module is coupled to the application module, via the communication network 30. The simulation module 50 includes means for accessing the data storage module 70 via the communication network 60. The storage module 80 is coupled via the communication network 80 to the external resource management module 82, to the external planning module 84 and to a performance management module 86 adapted in particular to collect information related to the actual condition of the equipment—an apparent age, a state of degradation and use, etc.—and of their constituent—dissolved gas, oil—read by inspections or sensors during interventions or automatically.

1. A method for managing a set of equipment, said equipment being comprised in at least one physical network infrastructure, characterized in that it includes the following steps:
a first step of obtaining a conceptual model of the physical network infrastructure and of the business processes including:
at least one type of equipment; and,
at least one type of link between one or more type(s) of equipment; and,
at least one type of interaction between one or more type(s) of equipment; and,
at least one type of dynamics related to a type of action;
a second step of automatically generating, according to the conceptual model, a computer simulation program;
a third step of collecting a set of data related to the physical network infrastructure and to the business processes related to the physical network infrastructure;
a fourth step of creating an instance of the conceptual model;
a fifth step of obtaining a set of actions to be undertaken by execution of the computer simulation program, X for a period between an initial year and a final year, by:
for each year n comprised between the initial year and the final year:
determining a planning for said yearn using the instantiated model;
for each week s of said year n:
by means of the instantiated model and of the planning for said year n, performing a simulation of the aging of the equipment of the set of equipment, for the week s of said year n, so as to obtain a list L_{s,n} of equipment likely to fail during the week s;
updating the planning for said year n according to the list L_{s,n} of equipment likely to fail during the week s and at least one constraint;
by means of the instantiated model and of the planning for said updated year n, performing a simulation of the aging of equipment of the set of equipment, for the week s of said year n, and checking if a condition is satisfied;
determining at least one measurement related to the risks for said year n, using the planning for said year n and the results obtained for each week s of said year n during simulations of the aging of the equipment of the set of equipment;
a sixth step of executing the set of actions in the physical network infrastructure.

2. The method according to claim 1 wherein the set of equipment comprises at least one equipment comprised in a second infrastructure.

3. The method according to claim 1, wherein the computer simulation program is adapted during its execution, to provide:
at least one information related to a risk analysis based on taking into account performance key values, each of these performance key values being measured using one or more indicator(s) related to the physical network infrastructure; and/or,
at least one indicator complementary to the risk analysis.
The set of actions to be undertaken obtained during the fifth step is then function of said at least one information related to the risk analysis and/or of said at least one complementary indicator.

4. The method according to claim 3, wherein said at least one information related to a risk analysis is obtained by implementing a risk analysis method using a consequence/probability-type matrix applied to the physical network infrastructure field.

5. The method according to claim 1, further including a step during which at least one global indicator is determined depending on said at least one risk-related measurement for each year in the period between the initial year and the final year.

6. The method according to claim 1, wherein the conceptual model of the physical network infrastructure and of the business processes may include at least one type of suitable physical equipment including at least a property related to a level of degradation over time.

7. The method according to claim 6, wherein the conceptual model of the physical network infrastructure and of the business processes includes at least one type of renewal and maintenance policy related to said at least one type of physical equipment and to at least one type of associated operation.

8. The method according to claim 6, wherein the conceptual model of the physical network infrastructure and of the business processes includes at least one type of physical replacement equipment availability constraints.

9. The method according to claim 1, wherein the conceptual model of the physical network infrastructure and of the business processes includes at least one type of constraints of the physical network infrastructure, inherent to the maintenance of a determined level of customer power quality.

10. The method according to claim 1, wherein the conceptual model of the physical network infrastructure and of the business processes includes at least one type of human resource constraints.

11. The method according to claim 1, wherein the conceptual model of the physical network infrastructure and of the business processes includes at least one type of budgetary constraints

12. The method according to claim 1, wherein the set of actions to be undertaken, for the period between the initial year and the final year, can be stored in a database.

13. A computer program including instructions for performing the steps of one of the methods according to claim 1, when said program is executed by a processor.

14. A computer-readable recording medium on which a computer program is recorded comprising instructions for performing the steps the steps of the methods according to claim 1.

15. A system for strategically managing a set of equipment, said equipment being comprised in at least one physical network infrastructure, characterized in that it includes:
means adapted to obtain a conceptual model of the physical network infrastructure and of the business processes including:
at least one type of equipment; and,
at least one type of link between one or more type(s) of equipment; and,
at least one type of interaction between one or more type(s) of equipment; and,
at least one type of dynamics related to one type of action;
means adapted to generate automatically, according to the conceptual model, a computer simulation program;
means adapted to collect a set of data related to the physical network infrastructure and of the business processes related to the physical network infrastructure;
means adapted to create an instance of the conceptual model according to the set of collected data;
means adapted to obtain a set of actions to be undertaken by execution of the computer simulation program, for a period between an initial year and a final year, by:
for each year n comprised between the initial year and the final year:
determining a planning for said year n using the instantiated model;
for each week s of said year n:
by means of the instantiated model and of the planning for said year n, performing a simulation of the aging of the equipment of the set of equipment, for the week s of said year n, so as to obtain a list Ls,n of equipment likely to fail during the week s;
updating the planning for said year n according to the list Ls,n of equipment likely to fail during the week s and to at least one constraint;
by means of the instantiated model and of the planning for said updated year n, performing a simulation of the aging of the equipment of the set of equipment, for the week s of said year n, and checking if a condition is satisfied;
determining at least one risk-related measurement for said year n, using the planning for said year n and the results obtained for each week s of said year n during simulations of the aging of the equipment of the set of equipment;
means adapted to execute a set of actions in the physical network infrastructure.

16. The method according to claim 2, wherein the computer simulation program is adapted during its execution, to provide:
at least one information related to a risk analysis based on taking into account performance key values, each of these performance key values being measured using one or more indicator(s) related to the physical network infrastructure; and/or,
at least one indicator complementary to the risk analysis.
The set of actions to be undertaken obtained during the fifth step is then function of said at least one information related to the risk analysis and/or of said at least one complementary indicator.

17. The method according to claim 16, wherein said at least one information related to a risk analysis is obtained by implementing a risk analysis method using a consequence/probability-type matrix applied to the physical network infrastructure field.

18. The method according to claim 17, further including a step during which at least one global indicator is determined depending on said at least one risk-related measurement for each year in the period between the initial year and the final year.

19. The method according to claim 2, further including a step during which at least one global indicator is determined depending on said at least one risk-related measurement for each year in the period between the initial year and the final year.

20. The method according to claim 18, wherein the conceptual model of the physical network infrastructure and of the business processes may include at least one type of suitable physical equipment including at least a property related to a level of degradation over time.
